(19) United States
(12) Patent Application Publication
(10) Pub. No.: US 2023/0171379 A1
(43) Pub. Date: Jun. 1, 2023

(54) VIRTUAL DISTRIBUTED CAMERA, ASSOCIATED APPLICATIONS AND SYSTEM

(71) Applicant: T1V, Inc., Charlotte, NC (US)

(72) Inventors: Michael R. FELDMAN, Charlotte, NC (US); James E. MORRIS, Lake Wylie, SC (US)

(73) Assignee: T1V, Inc., Charlotte, NC (US)

(21) Appl. No.: 18/102,769

(22) Filed: Jan. 30, 2023

Related U.S. Application Data
(63) Continuation of application No. PCT/US2021/043920, filed on Jul. 30, 2021.
(60) Provisional application No. 63/058,909, filed on Jul. 30, 2020.
(60) Provisional application No. 63/082,667, filed on Sep. 24, 2020.

(51) Int. Cl. H04N 7/15; H04N 7/14

(52) U.S. Cl. CPC H04N 7/15; H04N 7/147

(57) ABSTRACT

A system includes a room display in a room that displays a remote window for a first remote participant that is not in the room using a video conferencing application, the room display being controlled by a server, a room microphone, a room speaker, and a room camera. The server runs a host application that receives a room video feed from the room camera and a room audio feed from the room microphone, receives a first video feed and a first audio feed from a first mobile device in the room, receives a second video feed and a second audio feed from a second mobile device in the room, detects a volume of the first audio feed and the second audio feed, sends a selected video feed associated with a loudest audio feed to the video conferencing application.

### CROSS REFERENCE TO RELATED APPLICATIONS

This application is a continuation of International Application No. PCT/US2021/043920, filed Jul. 30, 2021, which claims priority to U.S. Provisional Application No. 63/058,909, filed Jul. 30, 2020, and U.S. Provisional Application No. 63/082,667, filed Sep. 24, 2020, whose entire contents are incorporated herein by reference.

### BACKGROUND

In a hybrid meeting, multiple people are co-located in a conference room for a meeting and multiple people are located remotely (i.e., not in the conference room), there may be issues in creating a seamless experience, i.e., some things may be apparent to those co-located in the conference room that are not apparent to the remote users, such as individual reactions.

When a hybrid meeting is to be conducted, typically, an external speaker, microphone and camera are in the room. Since people may be spread out, especially under current distancing guidelines, multiple microphones may be needed. A video conference would be set-up via any available providers, e.g., Zoom, Webex, Teams, and so forth for the remote participants. The video signals associated with the video conference would be displayed on a large display in the conference room. All of the remote participants would join the video conference. For individuals in the room they would normally not join the video conference, or if they do, then they would mute their microphone and turn their speakers off so as to avoid feedback (echoes).

Multiple microphones may be needed to pick up the various people, who may be spread out due to social distancing. Multiple cameras may be needed in order to focus on a speaker or the other participants that may also be spread out. Multiple displays may be needed for all participants in the room to view, content being shared the remote participants and/or whomever is speaking at any given point in time. The expense to purchase all of this equipment may be very large.

In addition, when setting-up such a meeting would be hindered by needing to set-up, configure and control all of this equipment. While this may not be an issue for formal meetings over an extended time period, when the meeting is to be set up quickly or only for a short time period, this may be burdensome.

### SUMMARY

One or more embodiments are directed to a system that includes a room display in a room that displays a remote window for a first remote participant that is not in the room using a video conferencing application, the room display being controlled by a server, a room microphone, a room speaker, and a room camera. The server runs a host application that receives a room video feed from the room camera and a room audio feed from the room microphone, receives a first video feed and a first audio feed from a first mobile device in the room, receives a second video feed and a second audio feed from a second mobile device in the room, detects a volume of the first audio feed and the second audio feed, sends a selected video feed associated with a loudest audio feed to the video conferencing application.

One or more embodiments is directed to a system including a room display in a room that displays a remote window for a participant that is not in the room using a video conference application, the room display being controlled by a server and having a room speaker. The server runs a host application that receives a first video feed and a first audio feed from a first mobile device in the room, receives a second video feed and a second audio feed from a second mobile device in the room, combines the first audio feed and the second audio feed as a combined audio signal, detects a volume of the first audio feed and the second audio feed, sets a selected video feed associated with a loudest audio feed as an active window, and sends the combined audio signal and the selected video feed to a video conferencing application running on one of the first and second mobile devices.

One or more embodiments is directed to a system including a room display in a room that displays a remote window for a participant that is not in the room using a video conference application, the room display being controlled by a server and having a room speaker. The server runs a host application that receives a first video feed and a first audio feed from a first mobile device in the room, receives a second video feed and a second audio feed from a second mobile device in the room, combines the first audio feed and the second audio feed as a combined audio signal, combines the first video feed and the second video feed as a combined video signal, and sends the combined audio signal and the combined video signal to a video conferencing application running on one of the first and second mobile devices.

### BRIEF DESCRIPTION OF THE DRAWINGS

Features will become apparent to those of skill in the art by describing in detail exemplary embodiments with reference to the attached drawings in which:

FIGS. 1-3 illustrate a display system in accordance with embodiments including a room display and mobile devices within the room;

FIGS. 4 and 6-7 illustrate display system in accordance with embodiments including a room display and mobile devices within the room and what a remote participant's display will show;

FIG. 5 illustrate a display system in accordance with embodiments including a room display and mobile devices within the room in which a video conferencing application is run on one of the mobile devices and what a remote participant's display will show; and

FIGS. 8-11 illustrates a display system in accordance with embodiments including a room display and mobile devices within the room and what a remote participant's display will show.

### DETAILED DESCRIPTION

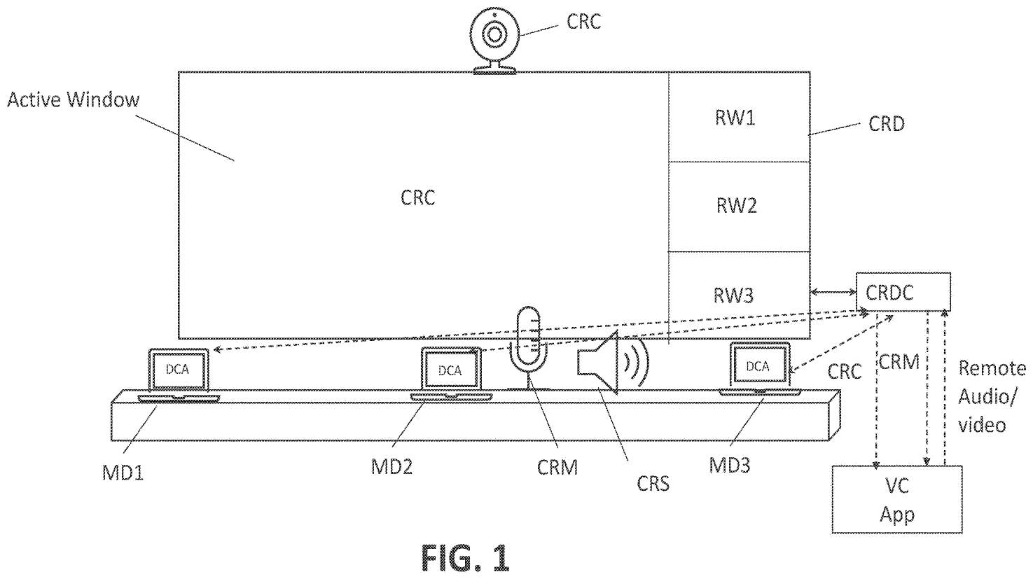

In accordance with one or more embodiments illustrated in FIGS. 1 to 9, instead of using all of the above equipment, have all of the in-room participants bring a mobile device (MD), e.g., a laptop computer, a tablet, a smartphone, and the like. Each mobile device includes a microphone, a display and a camera. Thus, the amount of equipment needed is reduced, saving cost, set-up time and complexity.

As shown in FIG. 1, a conference room camera CRC, a conference room microphone CRM and a conference room speaker CRS are provided and used in the conference room and associated with a conference room display CRD. All participants in the conference room download a Distributed Camera App (DCA) client App on their MD and connect to a conference room display computer (CRDC), which drives the CRD. A Video Conference is initiated with, e.g., a conventional Video Conferencing App, such as Zoom, Web-ex or Teams (VC App). Remote participants join the VC App as normal and activate the camera, speaker and microphone at their location. An image of each remote participant may be displayed in a corresponding remote window (RW) on the CRD. A conference room window CRW on the CRD may initially display an overview of the conference room. The CRS may be the default speaker. While a conference room microphone is illustrated herein as a single microphone adjacent to the conference room display, there may be multiple, distributed conference room microphones. Additionally, while the conference room microphone and the conference room speaker are illustrated as separate components, they may be single component.

The VC App may also be running on the CRDC. The DCA may also be running on the CRDC. Typically, the DCA Host App will run on the CRDC and the DCA Client Apps are running on the mobile devices in the room (MD1, MD2 and MD3 in FIGS. 1-7). Each DCA Client App will transmit the video and audio signals from the Mobile Device each is running on to the DCA Host App on the CRDC. Note that this will also enable the CRDC to determine these mobile devices are in the room.

As used herein ‘computer’ refers to circuitry that may be configured via the execution of computer readable instructions, and the circuitry may include one or more local processors (e.g., CPU's), and/or one or more remote processors, such as a cloud computing resource, or any combination thereof.

A Video Conference is initiated with, e.g., a conventional Video Conferencing App, such as Zoom, Web-ex, Teams, and so forth (VC App). Remote participants join the VC App as normal and activate the camera, speaker and microphone at their location to send into the Video Conference though the VC App.

The VC App running on each computer has two inputs (audio and video) and two outputs (also audio and video). For each remote participant, the audio input typically is the microphone on their laptop and the camera built into their laptop. The outputs are typically the speaker built into their laptop and the display on their laptop. Any of these inputs or outputs may be redirected to external components.

The CRDC computer may also join the video conference. A room may be arranged as in FIG. 1, where there is room for a person to address the room, near the front of the room, referred to here as the Chairperson of the meeting. There may also be multiple people sitting at desks in the room (in-room attendees). The in-room attendees may all have individual mobile laptop computers with them.

FIG. 1 illustrates how signals flow when the Chairperson of the meeting is speaking. Information from each of the in-room mobile devices is sent from these devices to the CRDC through the use of the DCA client apps and DCA Host app. The DCA Host App running on the CRDC is used to determine the audio and video inputs to the VC App from the CRDC. Note that the VC App would typically be running on the CRDC and each of the remote participants computers: RW1, RW2 and RW2. The audio inputs to the VC App for the remote participants would typically be the microphones on each of the remote participant's computers. The video inputs would be the cameras on their computers. The inputs from the CRDC are determined by the DCA Host App. In FIG. 1, when the Chairperson is speaking, the DCA Host App may configured so that the audio input for the VC App from the CRDC is the CRM and video input to the VC APP is the CRC. The audio output from the VC App in the conference room shown in FIG. 1 may be the CRS. The video output from the VC App may be the CRD or a window (CRW) located on the CRD. An image of each remote participant may be displayed in a corresponding remote window (RW), typically within the CRW. The CRW may also display the video output of the CRDC, which is initially as shown in FIG. 1, the CRC displaying an overview of the conference room. When the Chairperson is speaking the CRM picks up the signal and sends it to the DCA Host App and the DCA Host App sends this signal to the VC App. The VC App may send this audio signal to all of the participants in the VC conference except to the output associated with the CRDC, since this is the computer where the audio input came from. There may be no need for the CRS to be utilized when people in the room are speaking as everyone can hear each other. The purpose of the CRS is for when remote people are speaking. The preferred embodiment as shown in FIG. 1 the CRS is still active when the Chairperson is speaking, so that if someone remote speaks, their audio signal will be sent to the CRS. In an alternative embodiment, the CRS could be muted when the Chairperson is speaking. This has the disadvantage that people in the room would not be able to hear remote people when the Chairperson is speaking.

In-room participants may or may not join the VC App. For case 1, assume none of the in-room participants join the VC App. Instead they just run the DCA client App on their mobile devices. Each DCA client app sends information from the MD to a DCA Host App on the CRDC. This info may include the camera video feed and the microphone audio feed from the MD. The DCA host App may be running on a server computer, which may be in the conference room as illustrated or may be a cloud server. Therefore, the DCA Host App may receive the video and audio feeds from MDs for all of the in-room participants, as well as the video feed from the CRC and the audio feed from the CRM.

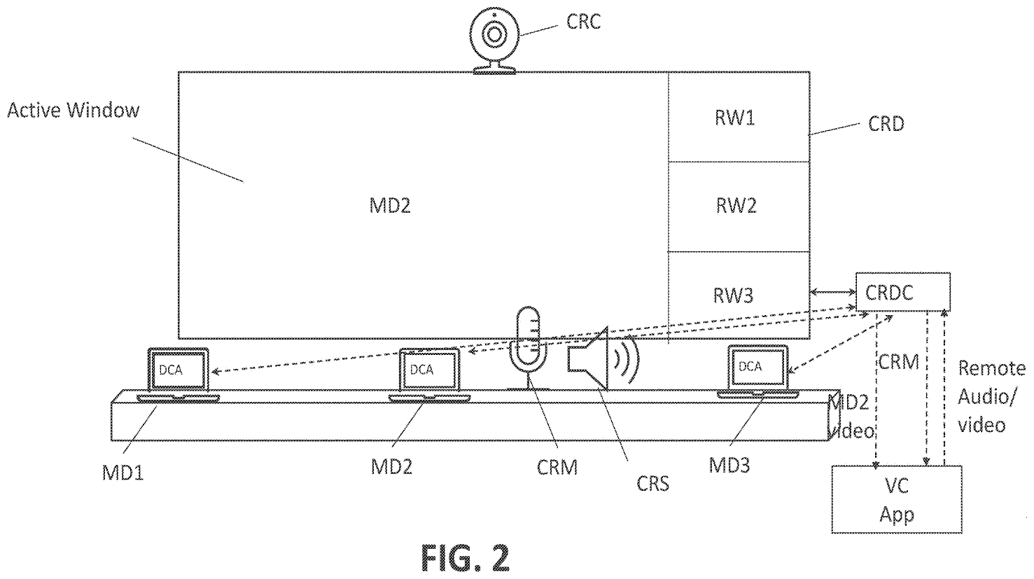

The CRDC can be configured so that the video inputs to the VC App are automatically changed when someone in the room speaks. This is illustrated in FIG. 2 and is referred to herein as a virtual distributed camera. When someone in the room speaks, the DCA Host App will detect this, from the audio feeds it receives from the DCA client Apps on the MDs and the audio feed from the CRM. By comparing the levels of the various audio feeds from the mobile devices, the DCA Host App can determine the mobile device that is closest to the person that is speaking, i.e., the microphone having the loudest audio feed. The DCA host computer (CRDC) can then send the camera feed associated with the loudest audio signal to the VC App. If the CRM is included in this comparison, e.g., there is a single room microphone, and is the selected audio feed is the CRM, or as a default option, the CRDC would configure the inputs to the VC App is in FIG. 1. If the CRDC selects MD2 as having the loudest audio feed then the CRDC may send the inputs to the VC App as shown in FIG. 2, i.e., the camera or video feed associated with the selected mobile device to the VC App, in this case the camera feed from MD2. If the CRM is muted or disregarded, audio from MD2 may also be sent to the VC App, which may provide a clearer audio signal to the remoter users, or otherwise audio from the CRM may be sent to the VC App as in FIG. 1, so that any other speaker in the conference room may still be heard, without any feedback issues, as only the audio stream is sent to the VC App. This camera feed may also be displayed in the conference room window, as shown in FIG. 2. Alternatively, the CRC feed may be continued to be displayed in the conference room, while the camera feed from MD2 is displayed for the remote viewers. The camera feed from MD2 may continue to be sent to the VC App until a volume of a different microphone in the conference room exceeds the volume of the current microphone as detected by the CRDC for a predetermined time, e.g., 2 seconds, or may revert back to the CRC view after a predetermined time, e.g., 5 seconds, during which the MD2 does not output an audio signal or the audio signal is below a threshold, or if the audio of the MD2 is manually muted.

Note that this is very different from how computers are normally designed to interact with VC Apps. Normally the inputs to the VC App are set at the start of the VC conference and may be manually changed, rather than dynamically and automatically changed as in embodiments disclosed herein.

Also, when someone in the room speaks, the sound will likely be detected on multiple microphones within the room. The CRDC can compare the signals from the various microphones to see if the audio signal is essentially the same on multiple microphones but at different levels. If so, the CRDC can simply determine the loudest signal and send that one to the VC App or may send both to the VC App.

When initially setting up the VC App, a microphone and speaker can be associated with the VC App. The microphone may be a virtual microphone, i.e., a microphone in a mobile device, that will be controlled by the DCA Host App and a default microphone may be the room microphone CRM.

When someone in the room speaks, you may want this sound to not come out of the room speaker. If it does come out of the room speaker, a feedback loop echo may occur, as the microphone of the speaking person's computer may pick up the sound from the room speaker. This may occur if there were for example multiple VC Apps running in the conference room at the same time. There are several ways to address this issue. One way is to simply mute the room speaker CRS whenever anyone in the room speaks. Furthermore, you could just ensure that at all times when someone in the room is speaking, there is only one microphone and no speakers in the room turned on. However, the problem with this is that it only allows one way communication (half duplex). Ideally, even when someone in the room is speaking the people in the room would still be able to hear if a remote person speaks. Another way is to configure the system so that the VC App will not send the audio in the room to the CRS as shown in FIG. 2. In FIG. 2, the set-up of the virtual microphone is associated with the room speaker. That is the audio input to the VC App running on the CRDC is the virtual microphone and the audio output of the VC App on the CRDC is sent to the CRS. In some cases, the VC App may output the audio input to the VC App to all participants, except to the one computer that contains the audio input. So by associating the virtual microphone audio input with the same computer with an audio output to the room speaker, there would be no need to mute the CRS with the system configured as in FIG. 2. In other words, to the VC App, all the in-room microphones and cameras would appear as a single feed with respect to the VC App.

As an alternative, it may be preferred to allow the CRM to pick up the voices from all participants in the room and always send the CRM audio signal to the VC App. In this case the individual audio feeds from each of the mobile devices could still be used to determine which video feed to send to the VC App. For example, in FIG. 2, the DCA would determine that the participant using MD2 was speaking the loudest as described previously. It would then send the CRM to VC App for the audio feed but would still send the video signal from the camera from MD2 as the video input into the VC App.

A third option for audio would be for the DCA to combine all of the individual audio microphone feeds of the devices in the room (e.g., MD1, MD2, MD3 and CRM in FIGS. 1-3) together and send them all to the VC App. As in the cases described above, the DCA Host App would still send the video feed based on the loudest audio signal as described above.

A further variation on the above is to send the audio output from the VC App to all of the DCA client apps, so that this signal would be output on all of the mobile device speakers in the room. In this case you could potentially eliminate any external speakers and microphones and utilize only mobile device speakers and microphones. Note that this would cause echo if the audio was distributed through a conventional VC App to all of the mobile devices. However, the echo could be eliminated by having a direct feed from the CRDC to each of the mobile devices all on the same network and by the use of the DCA App to combine all of the audio microphone inputs in to a signal audio signal in to the VC App so that it can be processed with standard echo cancellation either in the VC App or in the DCA App.

Virtual Camera: The DCA host may use a Virtual Camera interface to send video into a standard VC App. Those skilled will understand what a Virtual Camera is: i.e., rather than a physical camera, the DCA will send the info to the operating system of the CRDC required to act as a physical camera.

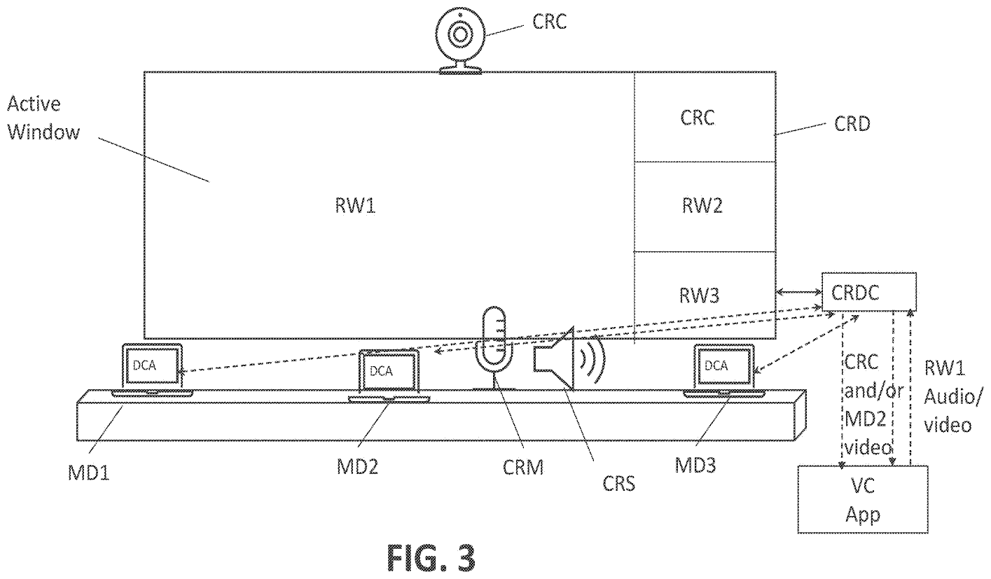

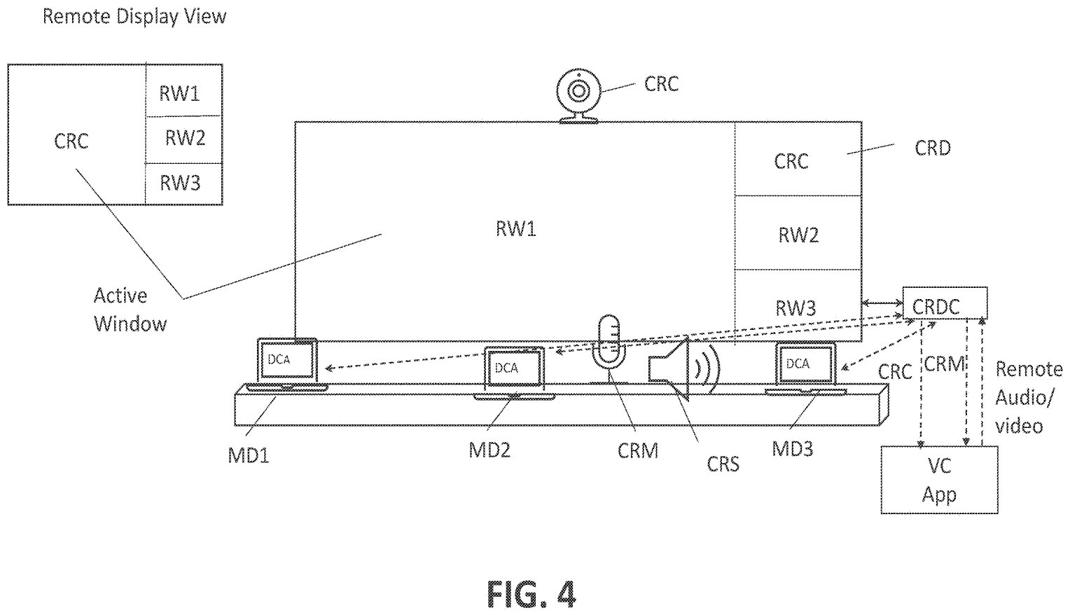

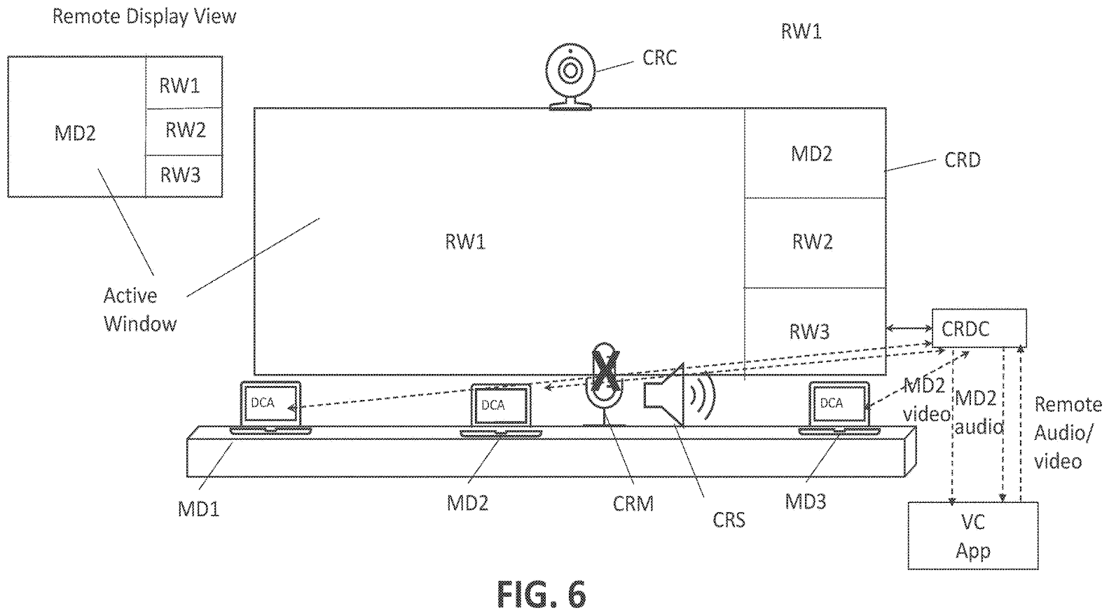

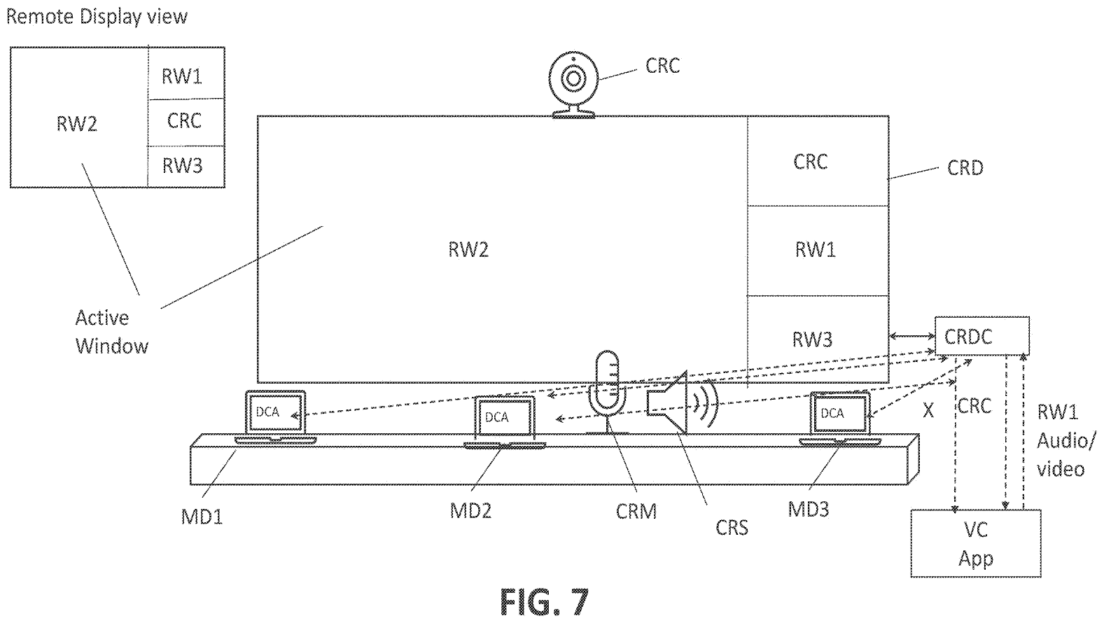

Consider now the CRW in FIGS. 1-7. The CRW displays the video output of the VC App. It may display all participants in the conference in small sub windows and whoever is speaking in a larger, “Active Window” section. In FIG. 1, the Chairperson is speaking and the Virtual Microphone is therefore sending the CRM to the VC App as well as the CRC, both from the CRDC. Therefore, the CRM audio feed is output to all of the remote participants on their computer. Correspondingly, the Active Window in the CRW is now coming from the CRDC and is therefore displaying the CRC. Similarly, in FIG. 2 someone in the room is speaking, so the Active Window will still display the video feed from the CRDC. But in this case the video feed coming from the DCA on the CRDC is now the camera feed from MD2. Therefore, the Active Window on the CRW would display the MD2 camera feed. In FIG. 3 a remote person is speaking so the Active Window on the CRW displays the feed from the remote person, in this case RW1. The other smaller windows in the CRW typically display all of the people that have joined the VC App that are not speaking or a subset of the participants that are not speaking or the last few people that have spoken. In the case of this embodiment of this invention (Case 1), the only people that have joined the Video Conference through the VC APP are the remote participants (RW1, RW2 and RW3) and the CRDC. Therefore, when a remote person is speaking as is the case for FIG. 3, the remote person (RW1) would appear in the Active Window within the CRW. RW2 and RW3 would appear in the smaller windows and the third smaller window would be the video feed sent by the CRDC. This video feed could be from the CRC or from the last person that spoke, e.g., the camera feed from MD2. As shown in FIG. 4, when the remote person (RW1) is speaking, the remote display would view the CRC or the last person that spoke as an active window, as well as all remote windows, and the RW1 would be the active window in the conference room display. As shown in FIG. 6, when MD2 is selected based on the volume or signal level of the audio feed, the active window in the remote display may now become the video feed from MD2, while the active window in the conference room display may be maintained as the active window or may revert back the video feed from the CRC. As shown in FIG. 7, when another remote participant is selected based on the volume or signal level of the audio feed, the active window in both the remote display and the conference room display now becomes the video feed for RW2. The remote display for the second remote participant may maintain the remote display view shown in FIG. 6.

In Case 2, people in the room join the VC App from their MDs and mute their microphones (as far as the VC App is concerned) and turn off the speakers on their computers. This has the advantage that each person can see themselves (and other speakers) on their own computer when someone is speaking. The room display may have a window showing whoever is speaking. Another room display shows content. To view all the remote participants, everyone in the room can see them on their own mobile device.

Case 2 also gives you the option that the DCA Host App, instead of sending the audio and video feeds to the VC App, they could just unmute the microphone of an in-room participant and mute the in-room speaker, when it detects that someone in the room is speaking (the speakers on all of the mobile devices could remain off to avoid feedback loops). Unmuting a person's microphone would allow the VC App to automatically switch the video feed to that of the speaking person's computer (rather than the CRDC switching the video feed). Note that in this case, while the microphones may be unmuted or muted in the VC App, all other the microphones could be unmuted in the DCA client APP so that they can be detected by the DCA Host App. One disadvantage of this approach is the delay involved in the muting and unmuting of the microphones.

In summary, in Case 1 only 1 in-room computer joins the video conference. Typically this would be the CRDC, but in a variation of Case 1, it could be one of the in room mobile devices. Therefore, only 1 video feed from the in-room computers is sent to the video conference. So, for example, remote users will see only the video feed of the CRC or one of the in-room mobile devices. This video feed will be the one selected by the DCA.

In summary for Case 2, all of the in-room mobile devices join the video conference along with the CRC. In this case, many or all of the in-room mobile devices may be viewed at the same time by remote users. The video feed selected by the DCA will be made larger or highlighted (or displayed as a second larger video) in order to indicate who is speaking. Combinations of Case 1 and Case 2 are also possible.

As far as audio goes, for both Case 1 and Case 2, the signal level for each microphone on the in-room mobile devices and the CRM are used to determine which video feed is selected by the DCA. In both Case 1 and Case 2 there is the option for audio to send only the CRM as the audio input to the video conferencing application, or the option to use the Virtual Microphone technique, in which a single microphone signal (chosen from the in-room mobile device microphones and the CRM) is selected by the DCA to send to the video conferencing app along with the video feed.

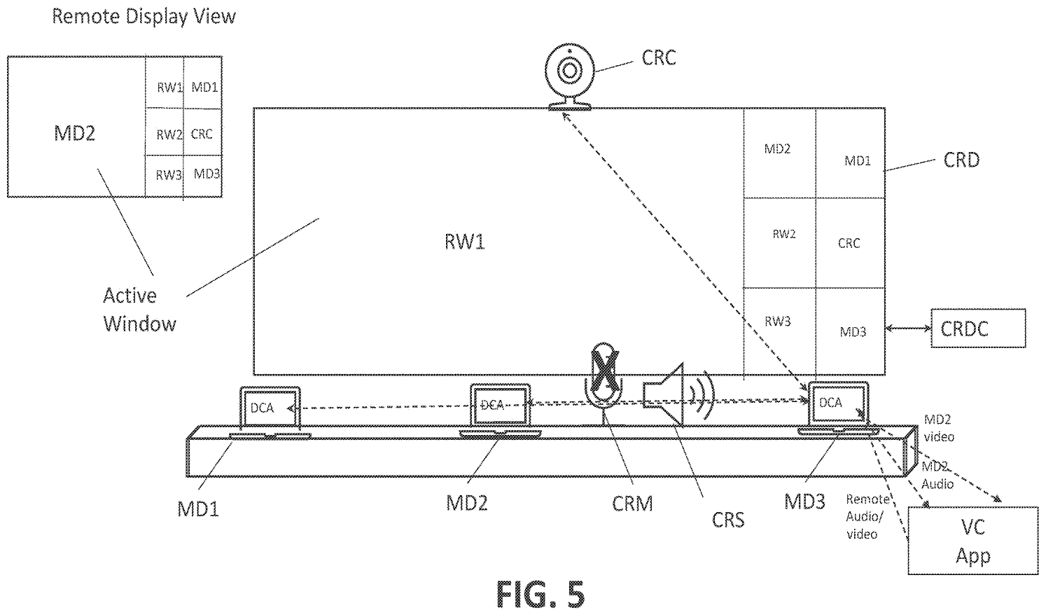

Case 2 could also be implemented with the use of the virtual microphone and distributed camera as shown in FIGS. 1-7. So that as in Case 1, the audio and video feeds are sent to the VC App through a computer in the cloud. The room microphone, room camera, and room speaker and all of the feeds in the room could be sent to a server in the cloud. As shown in FIG. 5, when a mobile device is running the VC App as well as the DCA, it may include its own associated window, so that the remote people would see everyone in the room, just as the remote people are viewed. The VC app may be run on the CRDC or one of the mobile devices.

Alternatively, the CRDC could just run ThinkHub® Cloud (which has a VC app, the DCA, and canvas application therein) disclosed in U.S. patent application Ser. No. 17/384,951 filed Jul. 26, 2021, which is hereby incorporated by reference, that would join the conference for the room and all audio and video signals from the mobile devices joining conference there in the room don't actually join the video conference. A first code may be used to join the meeting while in the room and a second code may be used to join the meeting remotely. This is one way the DCA may determine if a device is in the room or is remote. Another way to determine which devices are in room is to compare the audio signals on the microphones of each mobile device. Mobile devices with similar audio waveforms from people speaking in the room can be assumed to be in the same room. A third way would be for users to select an option in a menu on screen that they are in a particular room.

In both Case 1 and Case 2, when the DCA is used, when someone in the room other than the Chairperson speaks, the Active Video Window section for all participants viewing the conference in the VC App may switch to the camera view for the person speaking, e.g., MD2 in FIG. 2. In this case, then there would be no video feed into the conference for the room view, i.e., coming from the CRC. This situation could be resolved by setting up a second computer to join the video conference that could also have its audio input muted but have its video input to the VC App always coming from the CRC.

Also, although the use of MD1, MD2 and MD3 has been described as lap top computers any one or all of these may be mobile phones, tablets, Ipods® or other similar devices that contain at least a microphone or a microphone and a camera and/or a display.

FIG. 3 illustrates what happens when a remote participant speaks. In this case the audio input to the VC App from the CRDC would typically be the last audio feed that was sent, which could be MD1, MD2, MD3 or the CRM. If everyone is quiet in the room, there would be no audio signal sent. The video signal input could also be the last person that spoke or could be the CRC. The audio output form the VC App would be the remote person that is speaking, which in this case would be output from CRS, since the audio output would be different from the audio input.

While the room camera, room microphone and room speaker may be external components as illustrated herein, they may be integral with the room display CRD or may be from a designated mobile device.

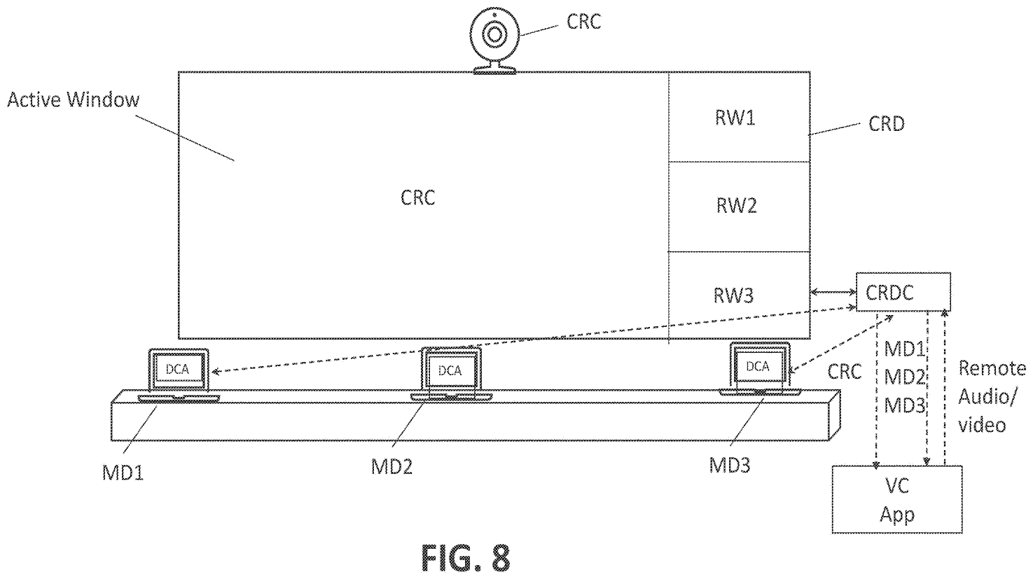

Alternatively, as illustrated in FIG. 8, the conference room may not include a separate microphone or speaker, and instead rely on the speakers and microphones in the mobile devices, each of which would now need to run the VC App as well as the DCA, i.e., this would proceed like case 2 discussed above. Here, initially and as a default, a mobile device camera and microphone, e.g., that of the Chairperson or host, may be designated as the room microphone.

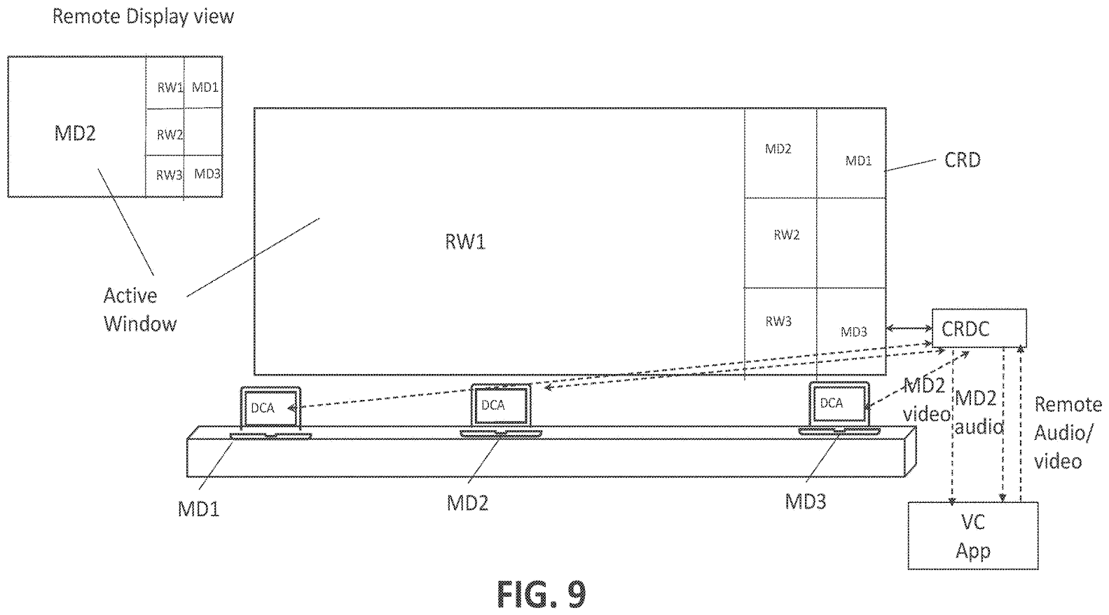

As a further alternative, as illustrated in FIG. 9, the conference room may not include a camera, an external speaker or microphone. Here, initially and as a default, a mobile device camera and microphone, e.g., that of the Chairperson or host, may be designated as the room microphone and the camera.

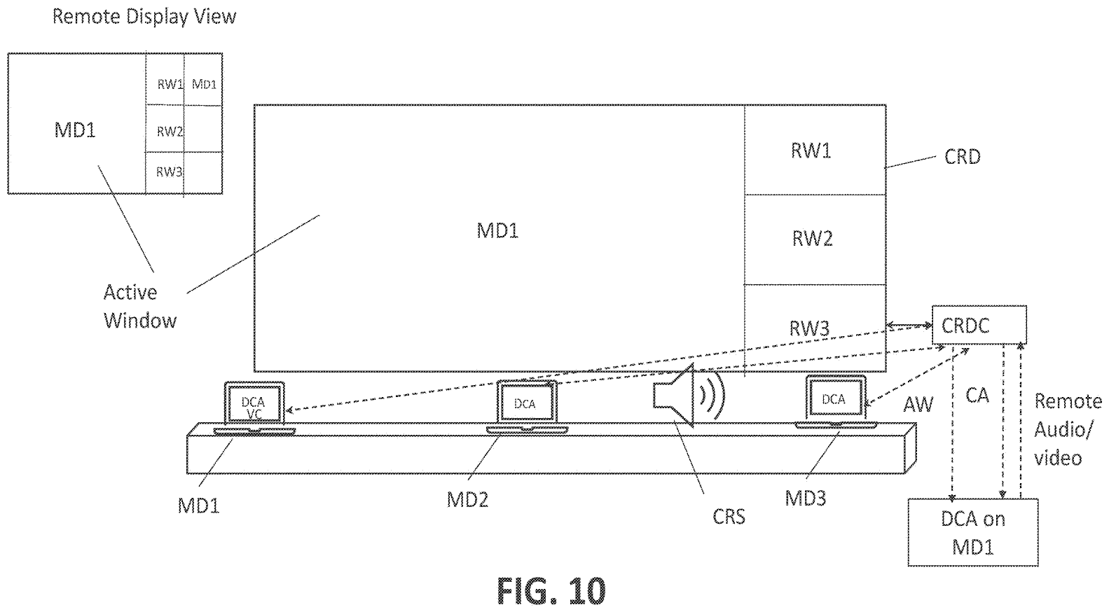

As another alternative, as illustrated in FIG. 10, rather than running the VC App on the Conference room display computer, the VC App may be run on a mobile device serving as a host for the VC App, e.g., MD1. Each mobile device, including the mobile device hosting the VC App, may run the DCA client App and the conference room display computer still runs the DCA host App. Each mobile device may also run a display application thereon to assist in connecting to the conference room display computer. Such an application may be written for each common operating system and is herein referred to as an AirConnect™ App. The AirConnect™ App may allow participants to share their screens. The DCA client App may be incorporated into the AirConnect™ App. The mobile devices MD1-MD3 send the output from their microphones and cameras to the conference room display computer. The DCA host app of the CRDC then combines the audio from the mobile devices into a combined audio signal CA and outputs the CA and an active window (AW), e.g., video associated with a current or most recent loudest speaker, to the DCA client Apps to all mobile devices. The mobile device MD1 then outputs the CA and AW to the VC app. The VC app on the mobile device MD1 then sends these to the remote participants. The VC app on the mobile device MD1 receives the remote audio/video feeds from the remote participants and outputs these to the CRDC to be displayed on the conference room display and output from the conference room speaker CRS. Thus, a conference room camera and a conference room speaker may not be needed.

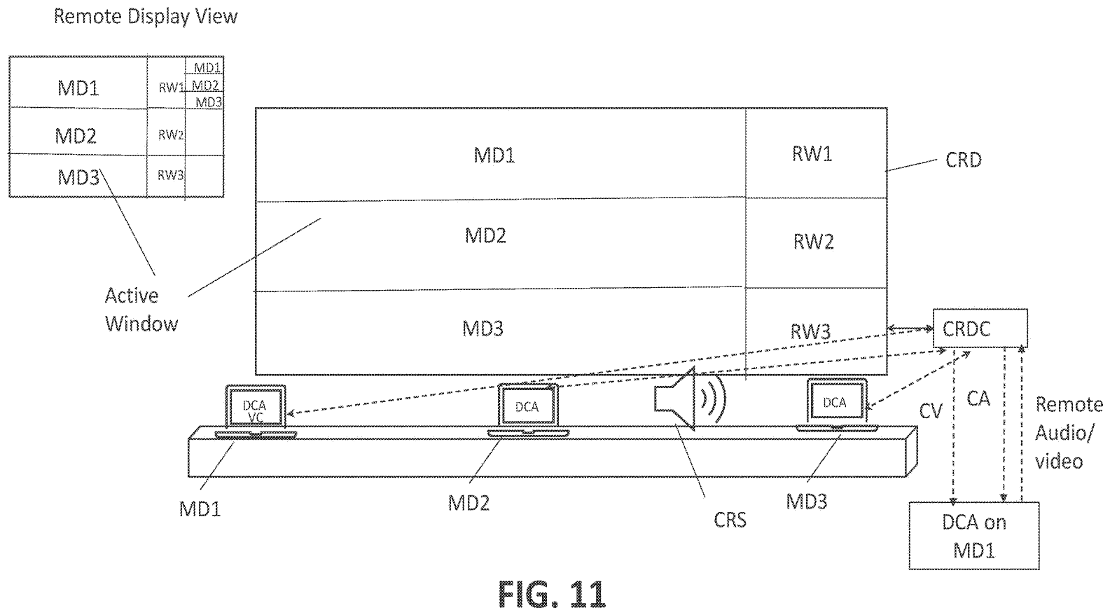

As a further example, as illustrated in FIG. 11, the VC App is again run on a mobile device, e.g., MD1. Here, instead of CRDC sending an active window to the MD1 to be used in the Virtual Camera on MD1, the CRDC outputs a composite of some (see the subset noted above) or all of the mobile device videos to the MD1, such that the multiple videos from the mobile devices are shown in a single window. In other words, a single composite video signal is sent to MD1 and then sent to the VC App, through the Virtual Camera on MD1. Therefore, as long as the microphone for MD1 is unmuted, then when someone in the conference room is speaking, the composite video will be the active window in the VC App.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, various changes in form and details may be made without departing from the spirit and scope of the embodiments set forth in the claims.

What is claimed is:

1. A system, comprising:
a room display in a room that displays a remote window for a first remote participant that is not in the room using a video conferencing application, the room display being controlled by a server,
a room microphone,
a room speaker, and
a room camera, wherein
the server runs a host application that receives a room video feed from the room camera and a room audio feed from the room microphone, receives a first video feed and a first audio feed from a first mobile device in the room, receives a second video feed and a second audio feed from a second mobile device in the room, detects a volume of the first audio feed and the second audio feed, sends a selected video feed associated with a loudest audio feed to the video conferencing application.

2. The system as claimed in claim 1, wherein the selected video feed is sent with the audio feed from the room microphone to the video conferencing application.

3. The system as claimed in claim 2, wherein only the audio feed from the room microphone is sent to the video conferencing application.

4. The system as claimed in claim 1, wherein only the selected video feed is sent to the video conferencing application.

5. The system as claimed in claim 1, wherein the selected video feed is sent with the audio feed from the microphone having the loudest audio feed the video conferencing application.

6. The system as claimed in claim 1, wherein the room microphone is a single microphone, the server detects the volume of the room audio feed and sends the selected video feed associated with a loudest audio feed of the room audio feed, the first audio feed, and the second audio feed.

7. The system as claimed in claim 1, wherein the server switches to the room video feed after a predetermined time has passed since the selected audio feed is below a threshold or is muted.

8. The system a claimed in claim 1, wherein the server switches from the selected audio feed when another audio feed has a volume greater than the selected audio feed for a predetermined time.

9. The system as claimed in claim 1, wherein the server sends a video feed of all video feeds in the conference room to the video conferencing application and the selected video feed is in an active window.

10. The system as claimed in claim 1, wherein an active window on the room display is different from an active window on a remote display of the first remote participant.

11. The system as claimed in claim 1, wherein the first video feed and the second video feed are displayed on the room display.

12. The system as claimed in claim 1, wherein video feeds from remote windows are sent to the video conferencing application.

13. The system as claimed in claim 1, wherein the first and second video feeds are sent to the video conferencing application and the video conferencing application uses the selected video feed as an active window for a remote display.

14. The system as claimed in claim 1, wherein a second remote participant is using the video conferencing application and the video conferencing application uses a remote window for the second remote participant as an active window in the room display and in a remote display for the first remote participant.

15. The system as claimed in claim 1, wherein the video conferencing application outputs a composite signal of the first and second video signals.

16. The system as claimed in claim 1, wherein the server sends at least one of a video feed from a mobile device other than the selected video feed and a video feed from the room camera to the video conferencing application to the video, while the selected video feed is in an active window for the first remote participant.

17. The system as claimed in claim 1, wherein the selected video feed is in an active window on the room display.

18. A system, comprising:
a room display in a room that displays a remote window for a participant that is not in the room using a video conference application, the room display being controlled by a server and having a room speaker, wherein
the server runs a host application that receives a first video feed and a first audio feed from a first mobile device in the room, receives a second video feed and a second audio feed from a second mobile device in the room, combines the first audio feed and the second audio feed as a combined audio signal, detects a volume of the first audio feed and the second audio feed, sets a selected video feed associated with a loudest audio feed as an active window, and sends the combined audio signal and the selected video feed to a video conferencing application running on one of the first and second mobile devices.

19. A system, comprising:
a room display in a room that displays a remote window for a participant that is not in the room using a video conference application, the room display being controlled by a server and having a room speaker, wherein
the server runs a host application that receives a first video feed and a first audio feed from a first mobile device in the room, receives a second video feed and a second audio feed from a second mobile device in the room, combines the first audio feed and the second audio feed as a combined audio signal, combines the first video feed and the second video feed as a combined video signal, and sends the combined audio signal and the combined video signal to a video conferencing application running on one of the first and second mobile devices.
